(19) United States
(12) Patent Application Publication
(10) Pub. No.: US 2018/0219690 A1
(43) Pub. Date: Aug. 2, 2018

(54) COMMUNICATION SYSTEM, COMMUNICATION DEVICE, AND COMMUNICATION PROGRAM

(71) Applicant: NEC CORPORATION, Tokyo (JP)

(72) Inventors: Toru YAMADA, Tokyo (JP); Kyoji HIRATA, Tokyo (JP); Akira KAMEI, Tokyo (JP); Masahiro SERIZAWA, Tokyo (JP); Hotaka SUGANO, Tokyo (JP); Satoshi HASEGAWA, Tokyo (JP); Masashi SHIMOMA, Tokyo (JP)

(73) Assignee: NEC CORPORATION, Tokyo (JP)

(21) Appl. No.: 15/747,168

(22) PCT Filed: Jul. 28, 2016
(86) PCT No.: PCT/JP2016/072233

§ 371 Date: Jan. 24, 2018

(30) Foreign Application Priority Data
Aug. 5, 2015 (JP) 2015-155286

(51) Int. Cl. H04L 12/06; H04L 9/32; H04W 4/14

(52) U.S. Cl. CPC H04L 12/06; H04L 9/3226; H04L 63/0442; H04L 2209/80; H04W 4/14

(57) ABSTRACT

The present disclosure is a communication system that triggers a terminal by use of a short message, the communication system including a generation unit that generates a short message for triggering the terminal, the short message containing at least originator information and security information related to validity of the originator, and a determination unit that determines validity of the originator based on the security information.

### TECHNICAL FIELD

The present invention relates to a communication system, a communication device, and a communication program.

### BACKGROUND ART

A cellular communication function is widely used not only in voice calls and data communications of mobile phones, smartphones and the like but also used in devices for machine type communications (which are also called MTC devices), and the number of communication terminals including MTC devices (which are referred to hereinafter as UE (User Equipment) or communication terminals) is increasing.

In many machine type communications (MTC) applications, both a communication scheme that carries out activation from the MTC device side and a communication scheme that activates an MTC device from the network side are required. One example of a communication scheme that activates an MTC device from the network side is triggering. The triggering is done in order to activate an MTC device by an application through a network and establish a communication connection.

3GPP is studying a triggering method for an MTC device, and a plurality of methods are proposed in 3GPP TR 23.888. Among them is a method using a short message service (SMS).

Further, in 3GPP TS 23.682, the architecture of machine type communications (MTC) is defined as shown in FIG. 7. In this architecture, a UE (MTC device) is triggered from an external application server (AS) through network nodes such as an MTC server (SCS: Service Capability Server) and an MTC-IWF (MTC-Interworking Function). Note that the MTC-IWF may be a standalone entity or a functional entity of another network element. Further, the MTC device may be a computing device such as a mobile phone, a sensor, or an actuator.

Further, in the 3GPP MTC architecture shown in FIG. 7, Tsp, T4, T5a,b,c interfaces are defined as “control plane” interfaces, and the MTC server communicates with the MTC-IWF through the Tsp interface. The control plane is, in general, a signaling communication path that conveys traffic on a network, and it is known also as a transfer plane, a carrier plane, or a bearer plane.

On the other hand, the MTC device communicates with the MTC server through the “user plane” of the network in general. The user plane is a communication path that transmits user traffic such as voice communications or data communications (e.g., e-mail or Internet web information). Examples of messages on the control plane in cellular communications are paging messages, short message service messages, location area update messages, detach messages, attach messages and the like.

The device triggering is a message that is initiated by a network entity such as an application server (AS) and sent to a device through the control plane of a network in general. Because the device triggering is sent on the control plane, it does not require an IP address. Instead, it requires an external identifier such as a mobile station international subscriber directory number (MSISDN) or a uniform resource identifier (URI).

In the 3GPP architecture shown in FIG. 7, the external application server (AS) sends a triggering request message to the MTC server, and the MTC server receives this message and makes a triggering request to the MTC-IWF through the Tsp interface. The MTC-IWF receives the triggering request from the MTC server and performs authentication of the MTC server, which is a sender, based on the content of the triggering request message in coordination with the HSS. When the authorization is approved, the MTC-IWF performs mapping between the external identifier or the MSISDN of the MTC device and an internal identifier such as an international mobile subscriber identity (IMSI), and triggers the MTC device through the control plane interface such as T4 or T5a,b,c. Further, the MTC-IWF performs an operation to report a success or a failure of trigger distribution to the MTC server based on a result received through the T4, T5a,b,c interface.

An SMS-SC (Short Message Service-Service Centre) sends a triggering request containing the above-described triggering information to an MME/SGSN/MSC based on the IMSI, and the triggering message is sent from the MME/SGSN/MSC to the MTC device through a base station. The MTC device receives the triggering message and, when the triggering message is acceptable, it sends a network connection request signal to the MME/SGSN/MSC as a response, and the signal is then sent from the MME/SGSN/MSC through the SMS-SC to the MTC-IWF and the MTC server, whereby a communication connection is established between the MTC device and the MTC server,

Further, in the 3GPP architecture shown in FIG. 7, a Tsms interface is defined as a reference point for connecting the SMS-SC and the external short message entity (SME: Short Message Entity) in 3GPP. The SME transmits and receives short messages, and it is a mobile terminal such as a smartphone or a mobile phone capable of transmitting and receiving short messages, a device having such functions or the like. In the 3GPP network, the SME can establish communication with the MTC device by triggering the MTC device with use of a short message (SMS) through the Tsms interface.

CITATION LIST

### Non Patent Literature

### NPL1: “3rd Generation Partnership Project; Technical Specification Group Services and System Aspects; System Improvements for Machine-Type Communications”, 3GPP TR 23.888.

NPL2: “3rd Generation Partnership Project; Technical Specification Group Services and System Aspects; Architecture Enhancements to facilitate communications with Packet Data Networks and Applications”, 3GPP TS 23.682.
NPL3: “3rd Generation Partnership Project; Technical Specification Group Core Network and Terminals; Technical realization of the Short Message Service (SMS)”, 3GPP TS 23.040.

### SUMMARY OF INVENTION

### Technical Problem

According to 3GPP TS 23.040, when a “Device Triggering Short Message” code is contained in a protocol identifier (TP-PID: TP Protocol Identifier) in an SMS message that is received from an SME (Short Message Entity), the SMS-SC determines that this SMS message is a triggering message, not a normal SMS message. Then, the SMS-SC checks “OA: Originating Address”, and when the originating address is registered in a list, determines that it is a trusted originator, and advances the triggering procedure by the SMS message. On the other hand, when the originating address is not registered in the list, the SMS-SC stops the triggering procedure. Particularly, when the originating address of the triggering is an SME, there is no authentication of the MTC server or the like, and only “OA: Originating Address” is checked by the SMS-SC (Short Message Service-Service Centre). Thus, even when the originating address is a false originator by spoofing, if it is registered in the list, it is determined as a trusted originator and the triggering procedure is advanced. The method of triggering the MTC device using SMS has a problem that protection against false triggering caused by external spoofing is insufficient.

The present invention has been accomplished to solve the above problem and an exemplary object of the present invention is to provide a communication system, a communication device, and a communication program that can achieve secure triggering even when a short message is used for triggering to start a terminal.

### Solution to Problem

One exemplary aspect of the present invention is a communication system that triggers a terminal by use of a short message, the system including a generation unit configured to generate a short message for triggering the terminal, the short message containing at least originator information and security information related to validity of the originator, and a determination unit configured to determine validity of the originator based on the security information.

One exemplary aspect of the present invention is a communication device that generates a short message for triggering a terminal, the device including a generation unit configured to generate a short message for triggering the terminal, the short message at least containing originator information and security information to verify validity of the originator.

One exemplary aspect of the present invention is a communication device that determines a short message for triggering a terminal, the device including a receiving unit configured to receive a short message for triggering the terminal, the short message containing at least originator information and security information related to validity of the originator, and a determination unit configured to determine validity of the originator based on the security information.

One exemplary aspect of the present invention is a communication method that triggers a terminal by use of a short message, the method including generating a short message for triggering the terminal, the short message containing at least originator information and security information to verify validity of the originator, receiving the short message, and determining validity of the originator based on the security information.

One exemplary aspect of the present invention is a program that generates a short message for triggering a terminal, the program causing a processor of a communication device to execute a generation process to generate a short message for triggering the terminal, the short message containing at least originator information and security information to verify validity of the originator.

One exemplary aspect of the present invention is a program that determines a short message for triggering a terminal, the program causing a processor of a communication device to execute a receiving process to receive a short message for triggering the terminal, the short message containing at least originator information and security information related to validity of the originator, and a determination process to determine validity of the originator based on the security information.

### Advantageous Effects of Invention

According to the exemplary aspects of the present invention, it is possible to achieve secure triggering even when a short message is used for triggering to start a terminal.

### BRIEF DESCRIPTION OF DRAWINGS

FIG. 1 is a block diagram according to a first exemplary embodiment of the present invention.

FIG. 2 is a block diagram according to a second exemplary embodiment of the present invention.

FIG. 3 is a view illustrating TS-DELIVER.REG.

FIG. 4 is a view illustrating an operation according to the second exemplary embodiment of the present invention.

FIG. 5 is a view showing another aspect of an SME 10 according to the second exemplary embodiment of the present invention.

FIG. 6 is a view showing another aspect of an SMS-SC 20 according to the second exemplary embodiment of the present invention.

FIG. 7 is a diagram illustrating a related art of the present invention.

### DESCRIPTION OF EMBODIMENTS

An exemplary embodiment of the present invention is described hereinafter.

FIG. 1 is a block diagram according to a first exemplary embodiment of the present invention.

The first exemplary embodiment of the present invention is a communication system that triggers a terminal with use of a short message, and it includes a generation unit 1 that generates a short message for triggering the terminal which contains at least originator information and security information related to the validity of the originator, and a determination unit 2 that determines the validity of the originator (information) based on the security information.

The generation unit 1 is placed in, for example, an SME (Short Message Entity) or the like. A triggering instruction for starting a terminal which is generated by the generation unit 1 is generated with use of a short message. A short message contains at least, as a protocol identifier (TP Protocol Identifier: TP-PID), information indicating that this short message is a triggering message that requests triggering (e.g., Device Triggering Short Message) and originator information (e.g., OA (Originating Address)).

Further, in this exemplary embodiment, the generation unit 1 adds, to the short message, security information that verifies the validity of an originator (e.g., security code), in addition to the above-described information. The security code may be in any form as long as it can verify the validity of an originator, and for example it may be a security code based on random numbers, time information or history information or a security code generated by encrypting arbitrary information with a public key.

The determination unit 2 is placed in, for example an SMS-SC (Short Message Service-Service Centre) or the like. The determination unit 2 acquires information indicating a triggering message in the received short message (e.g., Device Triggering Short Message), and determines whether the received short message is a triggering message or not. When the received short message is a triggering message, the determination unit 2 acquires originator information (e.g., OA (Originating Address)), and determines whether the originator information is registered in its list.

When the originator information is registered in the list, the determination unit 2 verifies the validity of the originator based on the security information. An originator has validity if the originator SME address (OA) is registered in, for example, the list of the SMS-SC, and it is a reliable SME address that is allowed to send triggering to a receiving address terminal (e.g., UE) or the like. In another representation, a triggering signal from a valid originator is a triggering signal that originates from a “trusted SME”, as stated in, for example, 3GPP TS 23.040. Other representations include “a legitimate trigger SM” and a valid trigger short message, as stated in 3GPP TS 33.187.

In a method for verifying the validity of an originator based on security information, it is determined in advance by the generation unit 1 and the determination unit 2 how to verify the validity of an originator based on security information. Although a verification method is not particularly limited, in one exemplary method, when the security information is an arbitrary code, the generation unit 1 and the determination unit 2 may have this code in advance and verify the code. Alternatively, the validity may be verified by encrypting arbitrary information with a public key. Further alternatively, in the case where the security information is history information, the generation unit 1 and the determination unit 2 may have the history of transmitting and receiving triggering messages and verify it. When the validity of an originator is verified, it is determined that the received short message originates from a trusted SME, and the triggering procedure is advanced.

As described above, by adding a method of verifying whether a triggering signal using a short message (SMS) to a terminal (MTC device) from the outside originates from a trusted originator (e.g., SME), it is possible to achieve triggering of a terminal (MTC device) from the outside more securely even with use of a short message (SMS).

A second exemplary embodiment of the present invention is described hereinafter.

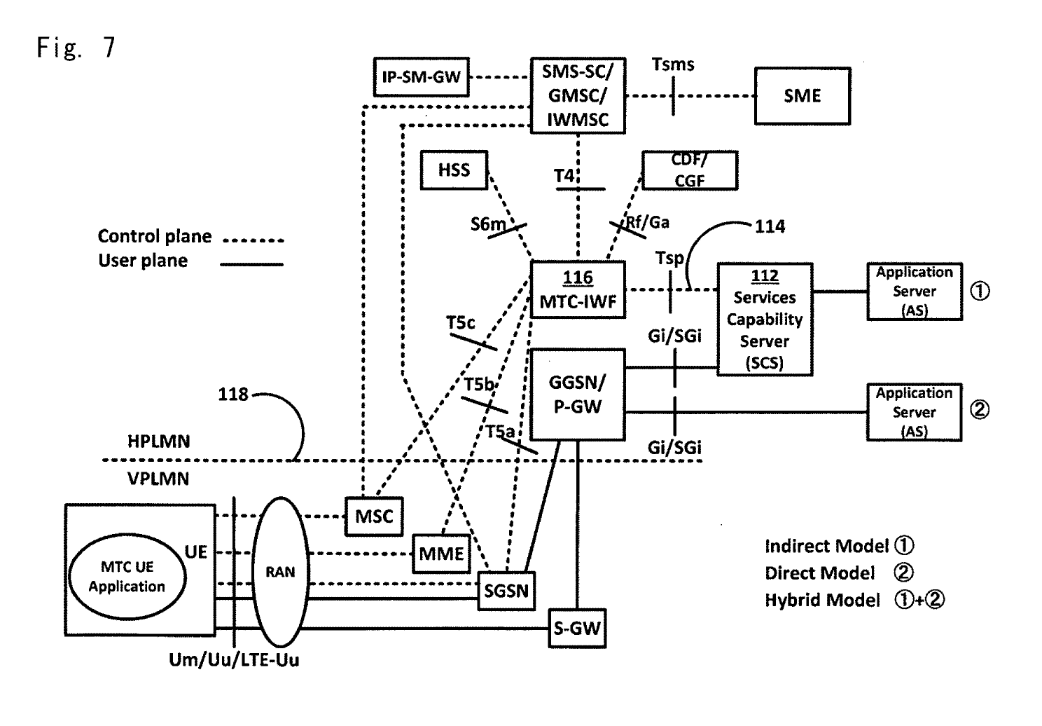

In the second exemplary embodiment of the present invention, a case is described where, in the 3GPP architecture shown in FIG. 7, the SME includes the generation unit 1, the SMS-SC includes the determination unit 2, and a reference point for connecting the SME and the SMS-SC is a Tsms interface.

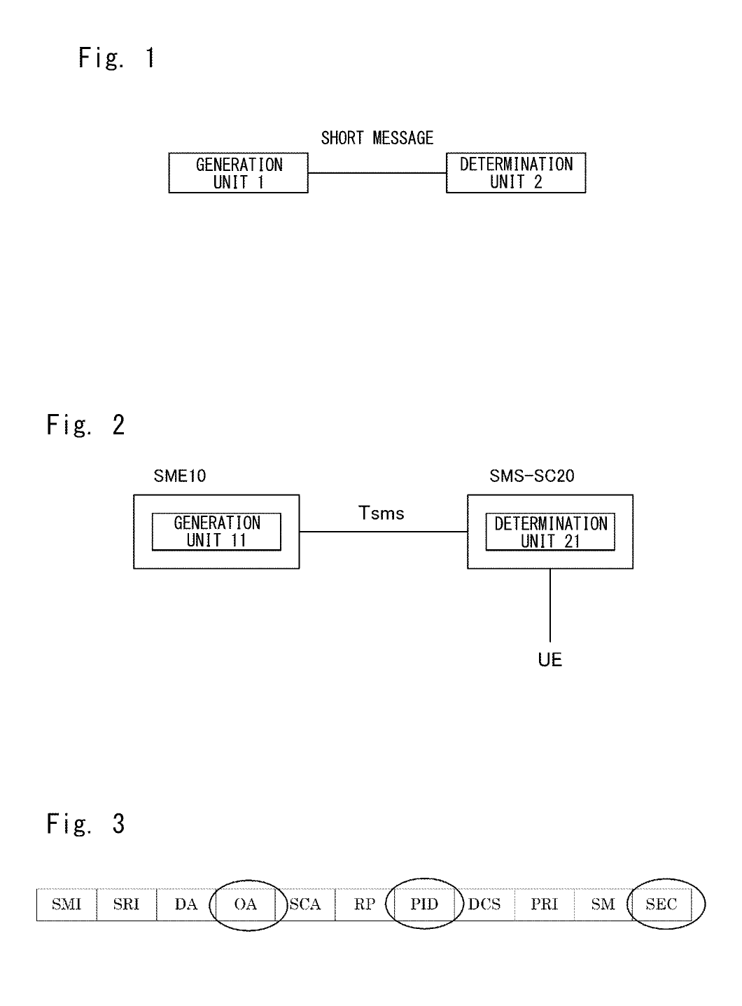

FIG. 2 is a block diagram according to the second exemplary embodiment of the present invention.

In FIG. 2, the reference numeral 10 designates the SME, and 20 designates the SMS-SC.

The SME 10 includes a generation unit 11. The generation unit 11 generates a TS-DELIVER.REG message, which is a short message (SMS) for triggering an external UE (MTC device). The generated TS-DELIVER.REG is as shown in FIG. 3.

“OA” stands for “Originating Address”, which is the address of an originator. In this exemplary embodiment, a case of using an OA (originating address) as the originator information is described. The generation unit 1 inserts its address into the “OA”.

Further, “PID” stands for “TP Protocol Identifier”, which is a protocol identifier. In 3GPP TS 23.040 9.2.3.9, when the low-order 5 bits of the TP Protocol Identifier are “001000”, this message is recognized as “a device triggering short message”. Therefore, the generation unit 11 inserts “001000” into “PID”.

Further, SEC is a security code for verifying the validity of the originating address “OA”.

The SMS-SC 20 includes a determination unit 21. In this exemplary embodiment, the SMS-SC 20 determines a specified security code, a public key and a private key, and sends the public key to the SME 10. Then, the SMS-SC 20 acquires information indicating a triggering message (e.g., a protocol identifier (TP Protocol Identifier: TP-PID)) in the received short message, and determines whether the received short message is a triggering message or not. When the received short message is a triggering message, the SMS-SC 20 verifies the validity of the triggering message.

Note that, the generation unit 11 in the SME 10 stores the received security code and public key. Then, when generating a triggering message (TS-DELIVER.REG), the generation unit 11 encrypts the stored security code with the public key, and adds the encrypted security code as the SEC to the triggering message (TS-DELIVER.REG).

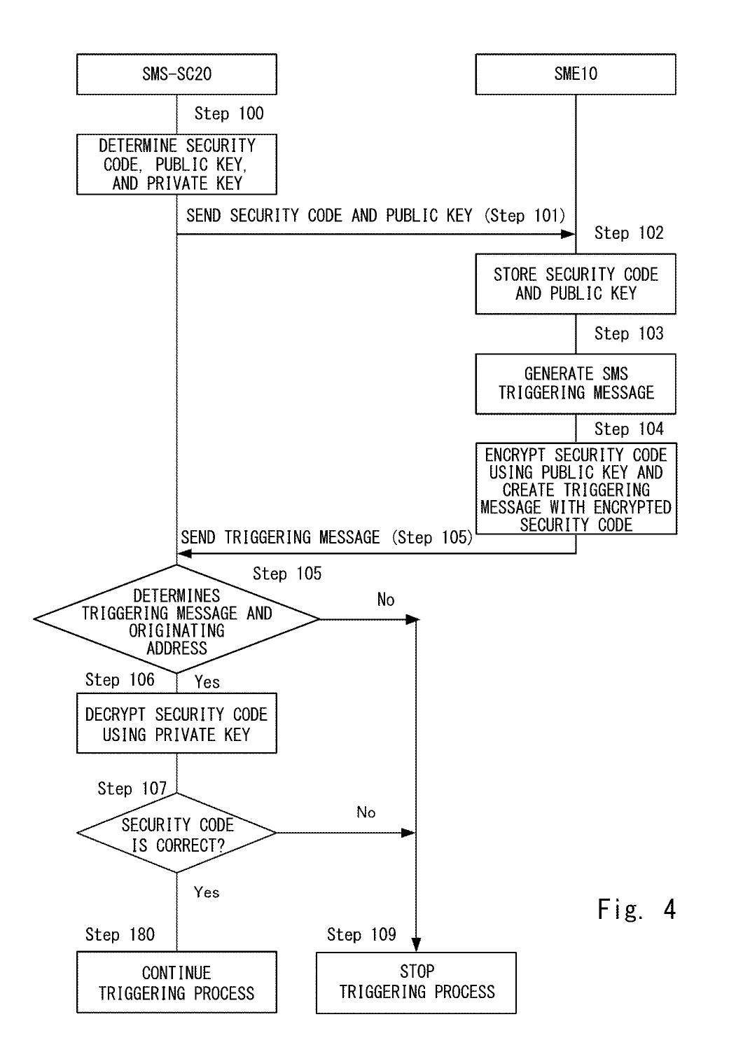

The operation in such a above configuration is described hereinafter. FIG. 4 is a view illustrating the operation according to the second exemplary embodiment of the present invention.

First, the SMS-SC 20 determines a specified security code, a public key and a private key (Step 100). The SMS-SC 20 then sends the determined security code and public key to the SME (Step 101). The SME stores the received security code and public key (Step 102).

After that, when triggering a UE, the SME 10 generates a triggering message (TS-DELIVER.REG) (Step 103). At this time, the SME 10 encrypts the stored security code with the public key, adds the encrypted security code to the triggering message (TS-DELIVER.REG), and thereby generates the triggering message (TS-DELIVER.REG) (Step 104). The SME 10 then sends the generated triggering message (TS-DELIVER.REG) to the SMS-SC 20 (Step 105).

The SMS-SC 20 receives an SMS message, and when “Device Triggering Short Message” code “001000” is found in a protocol identifier (TP Protocol Identifier: TP-PID) in the SMS message, the SMS-SC 20 checks “OA: Originating Address” (Step 106). When the originating address is registered in the list, the SMS-SC 20 decrypts the security code with the stored private key in order to verify the security code (Step 106). Then, the SMS-SC 20 determines whether the decrypted security code is the same as the stored security code or not (Step 107). When the decrypted security code is the same as the stored security code, it is determined as a trusted originator, and the triggering procedure by the SMS message proceeds to the next step (Step 108). On the other hand, when the decrypted security code is different from the stored security code, the triggering process stops, and the SMS message is discarded (Step 109).

According to this exemplary embodiment, it is possible to protect against false triggering caused by external spoofing for triggering of an MTC device even with use of SMS in a wireless communication network.

Although each of the units is implemented by hardware in the above-described exemplary embodiments, they may be implemented also by a program that causes an information processing device (a processor such as a CPU) to perform the above-described operation processing. In this case, the same functions and operation as those described in the above exemplary embodiments are implemented by a processor that operates by a program stored in a program memory.

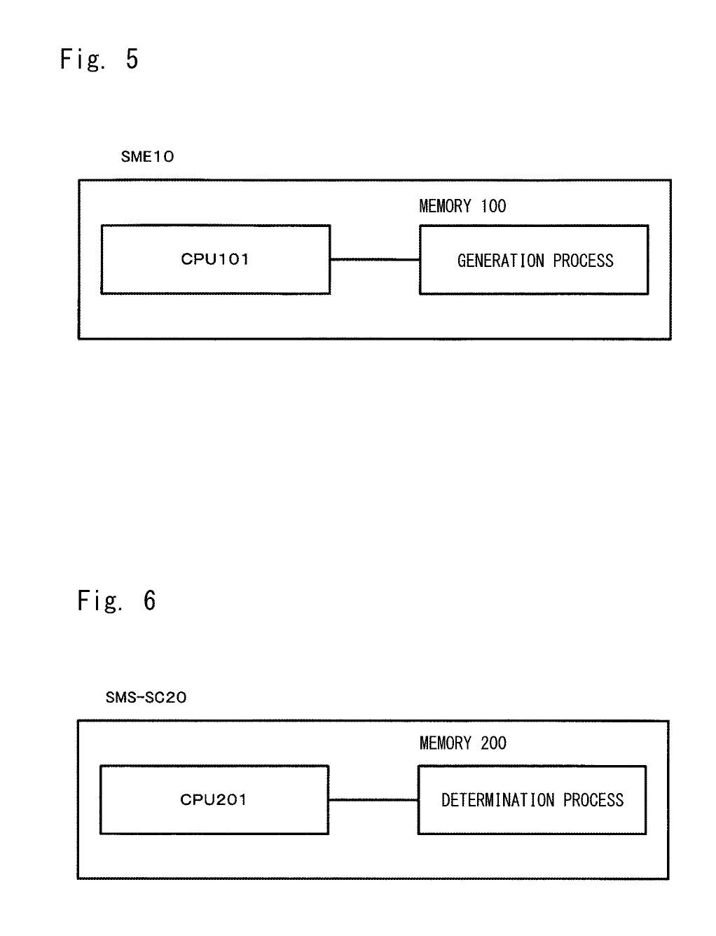

For example, the SME 10 may be implemented by a computer system composed of a memory 100 and a CPU 101 as shown in FIG. 5. In this case, a program that performs processing corresponding to the generation unit 11 described above is stored in the memory 100. The CPU 101 executes the program stored in the memory 100, and thereby the functions of the generation unit 11 are implemented.

Likewise, the SMS-SC 20 may be implemented by a computer system composed of a memory 200 and a CPU 201 as shown in FIG. 6. In this case, a program that performs processing corresponding to the determination unit 21 described above is stored in the memory 200. The CPU 201 executes the program stored in the memory 200, and thereby the functions of the generation unit 21 are implemented.

Further, the whole or part of the exemplary embodiments disclosed above can be described as, but not limited to, the following supplementary notes.

### Supplementary Note 1

A communication system that triggers a terminal by use of a short message, comprising:
a generation unit configured to generate a short message for triggering the terminal, the short message containing at least originator information and security information related to validity of the originator; and
a determination unit configured to determine validity of the originator based on the security information.

### Supplementary Note 2

The communication system according to Supplementary note 1, wherein
an SME (Short Message Entity) includes the generation unit, and
an SMS-SC (Short Message Service-Service Centre) includes the determination unit.

### Supplementary Note 3

The communication system according to Supplementary note 1 or 2, wherein
the generation unit generates the security information by encrypting a specified security code with a public key, and
the determination unit determines validity of the originator by decrypting the security information with a private key and verifying the decrypted security code with a stored security code.

### Supplementary Note 4

A communication device that generates a short message for triggering a terminal, comprising:
a generation unit configured to generate a short message for triggering the terminal, the short message at least containing originator information and security information to verify validity of the originator.

### Supplementary Note 5

The communication device according to Supplementary note 4, wherein the communication device is an SME (Short Message Entity).

### Supplementary Note 6

The communication device according to Supplementary note 4 or 5, wherein the generation unit generates the security information by encrypting a specified security code with a public key.

### Supplementary Note 7

A communication device that determines a short message for triggering a terminal, comprising:
a receiving unit configured to receive a short message for triggering the terminal, the short message containing at least originator information and security information related to validity of the originator; and
a determination unit configured to determine validity of the originator based on the security information.

### Supplementary Note 8

The communication device according to Supplementary note 7, wherein the communication device is an SMS-SC (Short Message Service-Service Centre).

### Supplementary Note 9

The communication device according to Supplementary note 7 or 8, wherein
the security information is generated by encrypting a specified security code with a public key, and
the determination unit determines validity of the originator by decrypting the security information with a private key and verifying the decrypted security code with a stored security code.

### Supplementary Note 10

A communication method that triggers a terminal by use of a short message, comprising:
generating a short message for triggering the terminal, the short message containing at least originator information and security information to verify validity of the originator; and
receiving the short message, and determining validity of the originator based on the security information.

### Supplementary Note 11

The communication method according to Supplementary note 10, wherein
an SME (Short Message Entity) generates the short message, and
an SMS-SC (Short Message Service-Service Centre) determines validity of the originator information based on the security information.

### Supplementary Note 12

The communication method according to Supplementary note 10 or 11, wherein
the security information is generated by encrypting a specified security code with a public key, and
validity of the originator is determined by decrypting the security information with a private key and verifying the decrypted security code with a stored security code.

### Supplementary Note 13

A program that generates a short message for triggering a terminal, the program causing a processor of a communication device to execute:
a generation process to generate a short message for triggering the terminal, the short message containing at least originator information and security information to verify validity of the originator.

### Supplementary Note 14

The program according to Supplementary note 13, wherein the communication device is an SME (Short Message Entity).

### Supplementary Note 15

The program according to Supplementary note 13 or 14, wherein the generation process generates the security information by encrypting a specified security code with a public key.

### Supplementary Note 16

A program that makes determines a short message for triggering a terminal, the program causing a processor of a communication device to execute:
a receiving process to receive a short message for triggering the terminal, the short message containing at least originator information and security information related to validity of the originator; and
a determination process to determine validity of the originator based on the security information.

### Supplementary Note 17

The program according to Supplementary note 16, wherein the communication device is an SMS-SC (Short Message Service-Service Centre).

### Supplementary Note 18

The program according to Supplementary note 16 or 17, wherein
the security information is generated by encrypting a specified security code with a public key, and
the determination process determines validity of the originator by decrypting the security information with a private key and verifying the decrypted security code with a stored security code.

Although the present invention is described using preferred exemplary embodiments, the present invention is not necessarily limited to the above-described exemplary embodiments and may be varied in many ways within the scope of the technical idea of the present invention.

This application is based upon and claims the benefit of priority from Japanese patent application No. 2015-155286 filed on Aug. 5, 2015, the disclosure of which is incorporated herein in its entirety by reference.

### REFERENCE SIGNS LIST

1 Generation Unit
2 Determination Unit
10 SME
11 Generation Unit
20 SMS-SC
21 Determination Unit
100 Memory
101 CPU
200 Memory
201 CPU

1. A communication system that triggers a terminal by use of a short message, comprising:
a generation unit configured to generate a short message for triggering the terminal, the short message containing at least originator information and security information related to validity of the originator; and
a determination unit configured to determine validity of the originator based on the security information.

2. The communication system according to claim 1, wherein
an SME (Short Message Entity) includes the generation unit, and
an SMS-SC (Short Message Service-Service Centre) includes the determination unit.

3. The communication system according to claim 1, wherein
the generation unit generates the security information by encrypting a specified security code with a public key, and
the determination unit determines validity of the originator by decrypting the security information with a private key and verifying the decrypted security code with a stored security code.

4. A communication device that generates a short message for triggering a terminal, comprising:
a generation unit configured to generate a short message for triggering the terminal, the short message at least containing originator information and security information to verify validity of the originator.

5. The communication device according to claim 4, wherein the communication device is an SME (Short Message Entity).

6. The communication device according to claim 4, wherein the generation unit generates the security information by encrypting a specified security code with a public key.

7. A communication device that determines a short message for triggering a terminal, comprising:
a receiving unit configured to receive a short message for triggering the terminal, the short message containing at least originator information and security information related to validity of the originator; and
a determination unit configured to determine validity of the originator based on the security information.

8. The communication device according to claim 7, wherein the communication device is an SMS-SC (Short Message Service-Service Centre).

9. The communication device according to claim 7, wherein
the security information is generated by encrypting a specified security code with a public key, and
the determination unit determines validity of the originator by decrypting the security information with a private key and verifying the decrypted security code with a stored security code.

10. A communication method that triggers a terminal by use of a short message, comprising:
generating a short message for triggering the terminal, the short message containing at least originator information and security information to verify validity of the originator; and
receiving the short message, and determining validity of the originator based on the security information.

11. The communication method according to claim 10, wherein
an SME (Short Message Entity) generates the short message, and
an SMS-SC (Short Message Service-Service Centre) determines validity of the originator information based on the security information.

12. The communication method according to claim 10, wherein
the security information is generated by encrypting a specified security code with a public key, and
validity of the originator is determined by decrypting the security information with a private key and verifying the decrypted security code with a stored security code.

13. A non-transitory computer readable medium storing a program that generates a short message for triggering a terminal, the program causing a processor of a communication device to execute:
a generation process to generate a short message for triggering the terminal, the short message containing at least originator information and security information to verify validity of the originator.

14. The non-transitory computer readable medium according to claim 13, wherein the communication device is an SME (Short Message Entity).

15. The non-transitory computer readable medium according to claim 13, wherein the generation process generates the security information by encrypting a specified security code with a public key.

16. A non-transitory computer readable medium storing a program that determines a short message for triggering a terminal, the program causing a processor of a communication device to execute:
a receiving process to receive a short message for triggering the terminal, the short message containing at least originator information and security information related to validity of the originator; and
a determination process to determine validity of the originator based on the security information.

17. The non-transitory computer readable medium according to claim 16, wherein the communication device is an SMS-SC (Short Message Service-Service Centre).

18. The non-transitory computer readable medium according to claim 16, wherein
the security information is generated by encrypting a specified security code with a public key, and
the determination process determines validity of the originator by decrypting the security information with a private key and verifying the decrypted security code with a stored security code.
